(19) United States
(12) Patent Application Publication
(10) Pub. No.: US 2009/0174641 A1
(43) Pub. Date: Jul. 9, 2009

(54) METHOD OF DRIVING LIQUID CRYSTAL DISPLAY DEVICE, AND LIQUID CRYSTAL DISPLAY APPARATUS

(75) Inventors: Masaki Nose, Kawasaki (JP); Tomohisa Shingai, Kawasaki (JP); Hirokata Uehara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/345,400

(22) Filed: Dec. 29, 2008

(30) Foreign Application Priority Data
Jan. 9, 2008 (JP) 2008-001957

(51) Int. Cl. G09G 3/36

(52) U.S. Cl. 345/89

(57) ABSTRACT

A drive circuit of a liquid crystal display device includes a driver circuit that applies a voltage pulse to a liquid crystal of the liquid crystal display device, and a control circuit that controls the driver circuit to change the liquid crystal to a initial tone and to change the initial tone to a high tone, an intermediate tone, or a low tone. The control circuit sets a tone energy difference so as to be smaller at the intermediate tone than at the high tone close to the initial tone, the tone energy difference being a difference between an application energy of the voltage pulse applied to the liquid crystal of the initial tone to display a predetermined tone and an application energy of the voltage pulse applied to display a tone different from the predetermined tone.

### CROSS-REFERENCE TO RELATED APPLICATIONS

This application is based upon and claims the benefit of priority from prior Japanese Patent Application No. 2008-001957, filed on Jan. 9, 2008, the entire contents of which are incorporated herein by reference.

### BACKGROUND OF THE INVENTION

1. Field

The present invention relates to a method of driving a liquid crystal display device, and a liquid crystal display apparatus.

2. Description of the Related Art

In recent years, companies and universities have been actively working on the development of electronic paper. As application areas where the use of electronic paper is expected, various application devices have been proposed such as sub displays of mobile terminal apparatuses, displays of IC cards, and most notably electronic books. A predominant form of electronic paper is cholesteric liquid crystal. Cholesteric liquid crystal has excellent characteristics such as semipermanent display holding (memorability), vivid color display, high contrast, and high resolution.

Cholesteric liquid crystal is also called chiral nematic liquid crystal. Cholesteric liquid crystal is a liquid crystal in which molecules of nematic liquid crystal form a helical cholesteric phase by adding a comparatively large amount (several tens of percent) of chiral additive (chiral material) to nematic liquid crystal.

FIGS. 1A and 1B are views for explaining the behavior of cholesteric liquid crystal. A liquid crystal display device 10 using cholesteric liquid crystal has an upper substrate 11, a cholesteric liquid crystal layer 12, and a lower substrate 13. Cholesteric liquid crystal has a planar state in which incident light is reflected, as shown in FIG. 1A, and a focal conic state in which incident light is transmitted, as shown in FIG. 1B. The planar state and the focal conic state are stably held even under a non-electrolytic condition.

In the planar state, cholesteric liquid crystal reflects light of a wavelength corresponding to the helical pitch of the liquid crystal molecules. The wavelength λ where the reflection is highest is expressed by the following expression from the average refractive index n and helical pitch p of the liquid crystal:

λ=n·p

On the other hand, the reflection band Δλ largely differs according to the refractive index anisotropy Δn of the liquid crystal.

In the planar state, since the incident light is reflected, a “bright” state is produced, that is, white can be displayed. On the other hand, in the focal conic state, by providing a light absorbing layer under the lower substrate 13, the light transmitted through the liquid crystal layer is absorbed, so that “dark” state, that is, black can be displayed.

Next, a display device driving method using cholesteric liquid crystal will be described.

FIG. 2 shows an example of a voltage-reflection characteristic of typical cholesteric liquid crystal. The horizontal axis represents the voltage value (V) of a pulse voltage applied, with a predetermined pulse width, between the electrodes sandwiching the cholesteric liquid crystal. The vertical axis represents the reflectance (%) of the cholesteric liquid crystal. The solid curved line P represents the voltage-reflectance characteristic of cholesteric liquid crystal, the initial state of which is the planar state. The broken curved line FC represents the voltage-reflectance characteristic of cholesteric liquid crystal, the initial state of which is the focal conic state.

In FIG. 2, when a relatively strong electric field is caused in the cholesteric liquid crystal by applying a predetermined high voltage VP100 (for example, ±36 V) between the electrodes, the helical structure of the liquid crystal molecules is completely disentangled, so that the liquid crystal is brought into a homeotropic state where all the molecules follow the direction of the electric field. Then, when the electric field in the liquid crystal is rapidly reduced to substantially zero by rapidly reducing the applied voltage from VP100 to a predetermined low voltage (for example, VF0=±4 V), and the liquid crystal molecules are in the homeotropic state, the helical axis of the liquid crystal is vertical to the electrodes, so that the liquid crystal is brought into the planar state where light corresponding to the helical pitch is selectively reflected.

On the other hand, when a relatively weak electric field is caused in the cholesteric liquid crystal by applying a predetermined low voltage VF100b (for example, ±24 V) between the electrodes, the liquid crystal is brought into a state where the helical structure of the liquid crystal molecules is not completely disentangled. Under this state, when the electric field in the liquid crystal is rapidly reduced to substantially zero by rapidly reducing the applied voltage from VF100b to the low voltage VF0, or the electric field is slowly removed by applying a strong electric field, the helical axis of the liquid crystal molecules becomes parallel to the electrodes, so that the liquid crystal is brought into the focal conic state where incident light is transmitted.

When the electric field is rapidly removed by applying an electric field of intermediate strength, the planar state and the focal conic state coexist, so that intermediate tones can be displayed.

Here, in the curved line P shown in FIG. 2, in the broken frame A, the reflectance of the cholesteric liquid crystal can be reduced by increasing the ratio of the focal conic state as the voltage value of the applied voltage pulse is increased. In the curved lines P and FC shown in FIG. 2, in the broken frame B, the reflectance of the cholesteric liquid crystal can be reduced by increasing the ratio of the focal conic state as the applied voltage value is reduced.

To display intermediate tones, the A area or the B area is used. When the A area is used, after the pixels are initialized to the planar state, a voltage pulse between VF0 and VF100a is applied so that the liquid crystal is partly in the focal conic state. When the B area is used, after the pixels are initialized to the focal conic state, a voltage pulse between VF100b and VP0 is applied so that the liquid crystal is partly in the planar state.

The principle of the driving method based on the above-described voltage response characteristic will be described. FIGS. 3A, 4A, and 4C show waveforms of voltage pulses. FIGS. 3B, 4B, and 4D show the pulse response characteristics when the voltage pulses of FIGS. 3A, 4A, and 4C are applied, respectively. FIG. 3A shows a voltage pulse the voltage value of which is ±36 V and the pulse width of which is several tens of ms. FIG. 4A shows a voltage pulse the voltage value of which is ±20 V at the time of ON and is ±10 V at the time of OFF and the pulse width of which is 2 ms. FIG. 4C shows a voltage pulse the voltage value of which is ±20 V at the time of ON and is ±10 V at the time of OFF and the pulse width of which is 1 ms. In FIGS. 3B, 4B, and 4D, the horizontal axis represents the voltage (V), and the vertical axis represents the reflectance (%). As the voltage-reflectance characteristic of FIG. 3B, the curved lines P and FC of FIG. 2 are schematically shown, and as the voltage-reflectance characteristic of FIGS. 4B and 4D, only the curved line P of FIG. 2 is schematically shown. The voltage pulses used here are a combination of positive and negative pulses to prevent degradation of liquid crystal due to polarization, as is well known.

As shown in FIGS. 3A and 3B, when the pulse width is large, if the initial state is the planar state, the liquid crystal is brought into the focal conic state when the voltage is increased to a certain range. When the voltage is further increased, the liquid crystal is brought into the planar state again. If the initial state is the focal conic state, the liquid crystal is gradually brought into the planar state as the pulse voltage is increased.

When the pulse width is large, the pulse voltage that always brings the liquid crystal into the planar state irrespective of whether the initial state is the planar state or the focal conic state is ±36 V in FIG. 3B. Moreover, with this intermediate pulse voltage, the planar state and the focal conic state coexist, so that intermediate tones are obtained.

On the other hand, as shown in FIGS. 4A and 4B, when the pulse width is 2 ms, if the initial state is the planar state, the reflectance does not change with a pulse voltage of ±10 V. However, if the voltage is higher than that, the planar state and the focal conic state coexist, so that the reflectance is decreased. Although the reflectance decrease amount increases as the voltage increases, when the voltage is higher than ±36 V, the reflectance decrease amount is constant. The same applies to a case where the planar state and the focal conic state coexist in the initial state. Therefore, when a voltage pulse with a pulse width of 2 ms and a pulse voltage of ±20 V is applied once in a case where the initial state is the planar state, the reflectance is decreased to some extent. When a voltage pulse with a pulse width of 2 ms and a pulse voltage of ±20 V is further applied in a state where the planar state and the focal conic state coexist (a state where the reflectance is slightly decreased) in this way, the reflectance is further decreased. By repeating this, the reflectance is decreased to a predetermined value.

As shown in FIGS. 4C and 4D, when the pulse width is 1 ms, similarly to when the pulse width is 2 ms, the reflectance is decreased by applying a voltage pulse. However, the degree of reflectance decrease is lower than when the pulse width is 2 ms.

From the above, the following are considered: When a pulse of ±36 V with a pulse width of several tens of ms is applied, the liquid crystal is brought into the planar state. When a pulse of several tens of V to approximately ±20 V with a pulse width of approximately 2 ms is applied, the liquid crystal is brought from the planar state into a state where the planar state and the focal conic state coexist, and the reflectance is decreased. The reflectance decrease amount is related to the cumulative time of the pulse.

Therefore, in a cholesteric liquid crystal display apparatus, at a first step, an initialization pulse of ±36 V with a pulse width of several tens of ms is applied to the pixels to be rewritten, whereby the liquid crystal is brought into the planar state. At the next second step, a tone pulse of approximately ±20.0 V with a narrow pulse width is applied to the pixels to be made intermediate tones, and the cumulative application times thereof are made values corresponding to the levels of the intermediate tones. In other words, this display method uses the area A of FIG. 2 to display intermediate levels.

In the display apparatus, a plurality of scan electrodes parallel to each other are provided on one surface of a display material layer. A plurality of data electrodes parallel to each other and intersecting the plurality of scan electrodes are provided on the other surface of the display material layer, and pixels are formed at the intersections of the scan electrodes and the data electrodes. In this description, the scan electrodes are referred to as scan lines, and the data electrodes are referred to as data lines. In the display apparatus, a common driver applies a scan pulse to the scan lines, and a segment driver applies a data pulse to the data lines.

At the first step, pulses are simultaneously applied to all the scan lines and all the data lines. At the second step, since the tone level is set for each pixel, by applying the data pulse to all the data lines while applying the scan pulse to one scan line, the voltage pulse is applied to the pixels in one scan line. In this way, the scan line to which the scan pulse is applied is shifted in sequence to end the application of the voltage pulse to all the scan lines.

At the second step, while a selective scan voltage corresponding to the scan pulse is being applied to one scan line, a non-selective scan voltage is applied to the other scan lines. A selective data voltage corresponding to the data pulse is applied to the data lines of the pixels where tone writing is performed, and a non-selective data voltage is applied to the data lines of the pixels where no tone writing is performed. Consequently, the following pixels are present: pixels where the selective scan voltage and the selective data voltage are applied; pixels where the non-selective scan voltage and the selective data voltage are applied; pixels where the selective scan voltage and the non-selective data voltage are applied; and pixels where the non-selective scan voltage and the non-selective data voltage are applied. It is necessary to set the selective scan voltage, the non-selective scan voltage, the selective data voltage, and the non-selective data voltage so that the reflectance (tone) is decreased only at the pixels where the selective scan voltage and the selective data voltage are applied and the reflectance (tone) is not decreased at the other three kinds of pixels.

In the display apparatus using cholesteric liquid crystal, as the tone pulses change from the planar state to intermediate levels, the segment driver and the common driver output, for example, pulses as shown in FIG. 5A. By applying such pulses, voltages as shown in FIG. 5B are applied to the pixels.

To the segment driver, 20 V is supplied as V0, and 10 V is supplied as V21S and V34S. In the positive phase (FR=1) a positive pulse is outputted, and in the negative phase (FR=0) a negative pulse is outputted.

To the common driver, 20 V is supplied as V0, 15 V is supplied as V21C, and 5 V is supplied as V34C. In the positive phase (FR=1), a negative pulse is outputted, and in the negative phase (FR=0), a positive pulse is outputted.

By the application of a pulse as shown in FIG. 5A, when the scan lines are in the selected state (common is ON) and the data lines are also in the selected state (segment is ON) 20 V is applied in the positive phase (FR=1), and −20 V is applied in the negative phase (FR=0). When the scan lines are in the selected state (common is ON) and the data lines are in the non-selected state (segment is OFF), 10 V is applied in the positive phase (FR=1), and −10 V is applied in the negative phase (FR=0). When the scan lines are in the non-selected state (common is OFF) and the data lines are in the selected state (segment is ON), 5 V is applied in the positive phase (FR=1), and −5 V is applied in the negative phase (FR=0). When the scan lines are in the non-selected state (common is OFF) and the data lines are in the non-selected state (segment is OFF), −5 V is applied in the positive phase (FR=1) and 5 V is applied in the negative phase (FR=0).

Therefore, the waveform of the voltage pulse applied to the pixels of the scan lines in the selected state is as shown in FIG. 6A, and the waveform of the voltage pulse applied to the pixels of the scan lines in the non-selected state is as shown in FIG. 6B. In both cases, the waveform of the data lines in the selected state is represented by a solid line, and the waveform of the data lines in the non-selected state is represented by a dotted line. As shown in FIG. 4B, in the case of a voltage pulse with a pulse width of 2 ms, the state of the liquid crystal, that is, the reflectance is changed when the voltage is ±20 V, and the reflectance is not changed when the voltage is ±10 V. Therefore, if the waveform is as described above, writing by the tone pulse is performed when both the scan lines and the data lines are ON, and otherwise, writing is not performed. Although there is a problem of crosstalk in actuality, this will not be described because it is not directly related to the present invention.

While the waveforms of the voltage pulses actually applied in the display apparatus are as shown in FIGS. 6A and 6B as described above, in the description that follows, the waveforms are sometimes expressed as positive and negative pulses symmetrical with respect to 0 V for simplification of explanation. Moreover, the voltage of the OFF pulse is set at a level where no writing is performed, and the pulse voltage indicates the voltage of the ON pulse.

For the multi-tone display method by cholesteric liquid crystal, various driving methods have been proposed. The driving methods for the multi-tone display by cholesteric liquid crystal are divided into two methods of dynamic driving and conventional driving.

Japanese Unexamined Patent Application Publication No. 2001-228459 describes a dynamic driving method. However, the dynamic driving method has a problem in which since the drive waveform is complicated, a complicated control circuit and driver IC are required, a low resistance electrode is required as the transparent electrode of the panel and this increases the manufacturing cost. The dynamic driving method also has a problem of high power consumption.

Y.-M. Zhu, D-K. Yang, “Cumulative Drive Schemes for Bistable Reflective Cholesteric LCDS,” SID 98 DIGEST, pp798-801, 1998 describes a conventional driving method. This document describes a method of driving liquid crystal at a comparatively high speed of quasi-video rate so as to gradually change from the planar state to the focal conic state or from the focal conic state to the planar state by using the cumulative time particular to the liquid crystal and adjusting the number of times of application of a short pulse.

When tones are set by using the cumulative time by the conventional driving method, methods are available in which the number of times of application of a short pulse is adjusted and in which the pulse width W is varied. The method in which the pulse width is varied is more advantageous in power consumption suppression than the method in which the number of times of application of a short pulse is adjusted. A method is also available in which the cumulative time of pulse application is varied for both of the pulse width and the number of times of pulse application. FIGS. 7A to 7D are views showing examples of voltage pulses in this method, and show voltage pulses and the tone condition that varies by applying them.

FIG. 7A shows an initialization pulse used at the first step. The pulse voltage is ±36 V, and has a comparatively large pulse width. By applying this pulse, the liquid crystal of the pixels is brought into the planar state, and the tone is highest. FIGS. 7B to 7D show first to third tone pulses used at the second step. Although the pulse voltages thereof are all ±20 V, the pulse width is shorter in the order of the first to third tone pulses. When the pulses of FIGS. 7B to 7D are applied, in the pixels, the liquid crystal is partly brought from the planar state to the focal conic state to decrease the tone, and the degree of tone decrease is lower in the order of FIGS. 7B to 7D. In other words, when the pulses of FIGS. 7B to 7D are applied, the tone becomes relatively low, intermediate, and high, respectively. In this description, the pulse shown in FIG. 7B is referred to as a low tone pulse, the pulse shown in FIG. 7C, as an intermediate tone pulse, and the pulse shown in FIG. 7D, as a high tone pulse. While only four tones can be expressed by applying any one of the pulses of FIGS. 7B to 7D or applying none of them, the three kinds of pulses shown in FIGS. 7B to 7D may be combined. For example, by combining a number, n, of periods T into one line period nT and selecting the pulse width in each period T, a multiplicity of tones can be expressed. Moreover, by performing the tone pulse application for a plurality of frames and selecting whether any one of the pulses of FIGS. 7B to 7D is applied or none of them is applied for each frame, a multiplicity of tones can be expressed.

### SUMMARY

According to an aspect of the invention, a drive circuit of a liquid crystal display device includes a driver circuit that applies a voltage pulse to a liquid crystal of the liquid crystal display device, and a control circuit that controls the driver circuit to change the liquid crystal to an initial tone and to change the initial tone to a high tone, an intermediate tone, or a low tone. The control circuit sets a tone energy difference so as to be smaller at the intermediate tone than at the high tone close to the initial tone, the tone energy difference being a difference between an application energy of the voltage pulse applied to the liquid crystal of the initial tone to display a predetermined tone and an application energy of the voltage pulse applied to display a tone different from the predetermined tone.

### BRIEF DESCRIPTION OF THE DRAWINGS

FIGS. 1A and 1B are views for explaining the planer state and the focal conic state;

FIG. 2 is a view for explaining the state change of the cholesteric liquid crystal by the pulse voltage;

FIGS. 3A and 3B are views for explaining the reflectance change by the pulse of the high voltage and the wide pulse width applied to the cholesteric liquid crystal;

FIGS. 4A to 4D are views for explaining the reflectance change by the pulses of the intermediate voltage and the two kinds of narrow pulse widths applied to the cholesteric liquid crystal;

FIGS. 5A and 5B are views showing the driver output voltages and the liquid crystal application voltages when the tone pulse is applied;

FIGS. 6A and 6B are views showing examples of symmetrical pulses applied to the liquid crystal;

FIGS. 7A to 7D are views showing examples of the initialization pulse and the plurality of tone pulses of different pulse widths applied to the liquid crystal;

FIG. 8 is a view showing the response characteristic (brightness decrease) of cholesteric liquid crystal with respect to the drive energy applied to the liquid crystal in the writing processing of an embodiment;

FIG. 9 is a view showing an example in which the relation of the energy cumulative value with the tone is changed in low tones;

FIG. 10 is a view showing the relation between the input tone and the output tone when the display range of low tones is expanded by changing the relation for the low tones;

FIG. 11 is a view showing the brightness change with respect to a pulse voltage change when the pulse is divided;

FIG. 12 is a view showing details of the response characteristic in high tones;

FIGS. 13A and 13B are views showing the brightness change with respect to the number of applied pulses when the pulse energy is constant and the voltage is varied in the high tones;

FIG. 14 is a view showing the lamination structure of the cholesteric liquid crystal device of a color display apparatus of the present embodiment;

FIG. 15 is a view showing the structure of one cholesteric liquid crystal device of the color display apparatus of the embodiment;

FIG. 16 is a view showing the schematic structure of the color display apparatus of the embodiment;

FIG. 17 is a view for explaining the tone display at a second step (writing processing) in the embodiment;

FIGS. 18A and 18B are views showing the output voltages of drivers and applied voltages at a first step (initialization processing) in the embodiment;

FIGS. 19A and 19B are views showing the output voltages of the drivers and the applied voltages at the second step (writing processing) in the embodiment;

FIGS. 20A and 20B are views showing the output voltages of the drivers and the applied voltages at the second step (writing processing) in the embodiment;

FIGS. 21A and 21B are views showing the output voltages of the drivers and the applied voltages at the second step (writing processing) in the embodiment; and

FIGS. 22A to 22C are views for explaining a full-screen planar reset processing at the first step (initialization processing) in the embodiment.

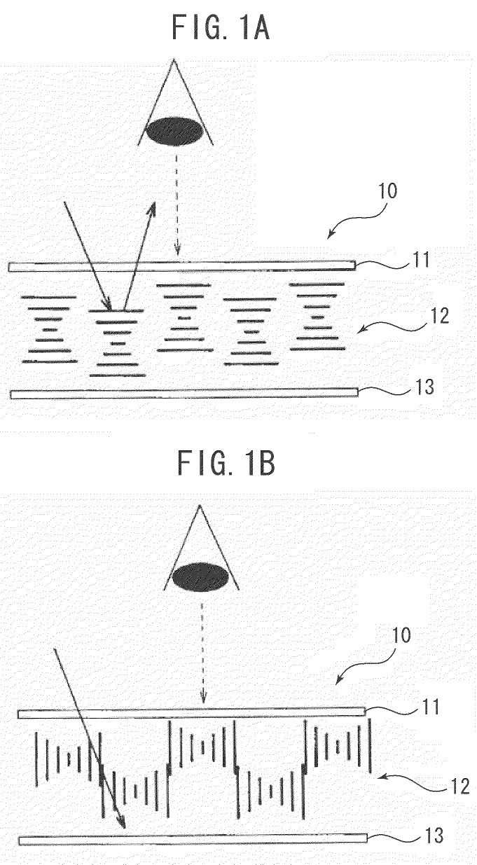

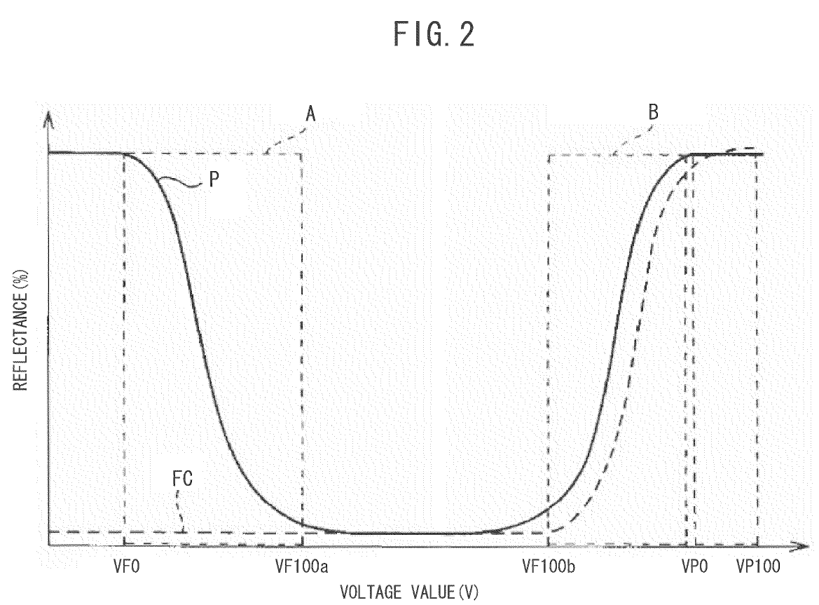

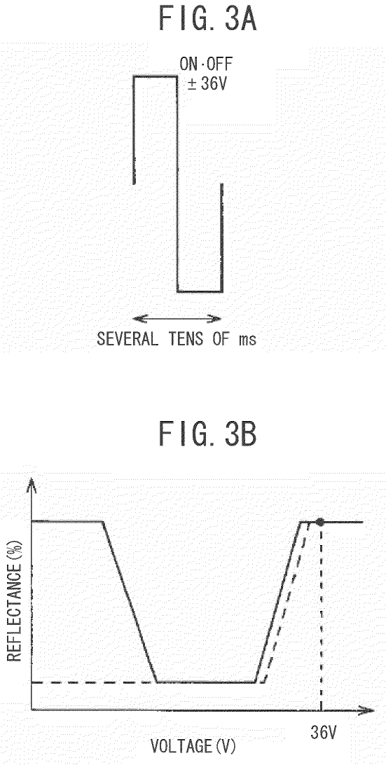

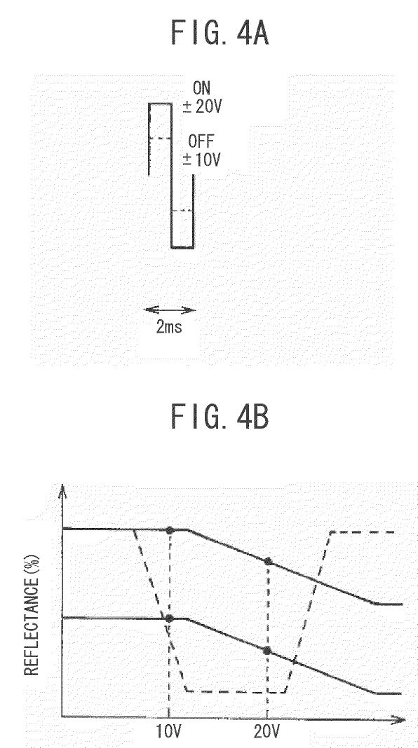

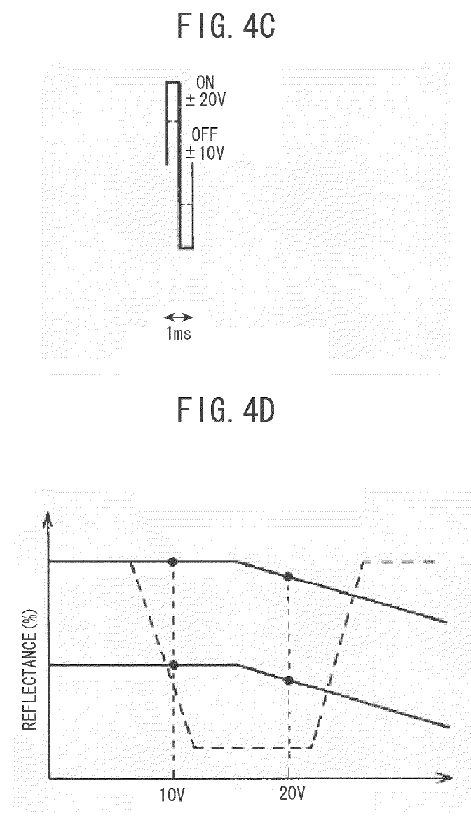

### DESCRIPTION OF THE PREFERRED EMBODIMENTS

The applicant examined a cholesteric liquid crystal display device driving method in which after a first step where the liquid crystal is initialized, a second step is performed where a plurality of sub pulses of a predetermined voltage, at least some of which have a different pulse width, are combined according to the tone, and the tone is set according to the pulse width cumulative value. In particular, the applicant examined the expansion of the display area of low tones by making the difference in pulse width cumulative value from adjoining tones in a low tone (shadow [dark tone]) part larger than those in an intermediate tone (mid tone) part and a high tone (highlight [bright tone]) part (see Japanese Patent Application No. 2007-111523). The disclosure of Japanese Patent Application No. 2007-111523 is incorporated in the present application.

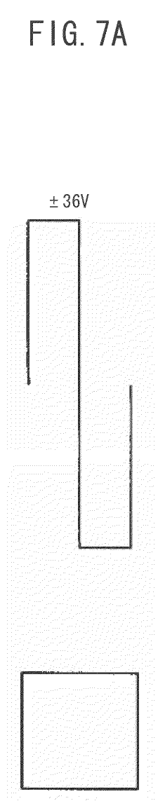

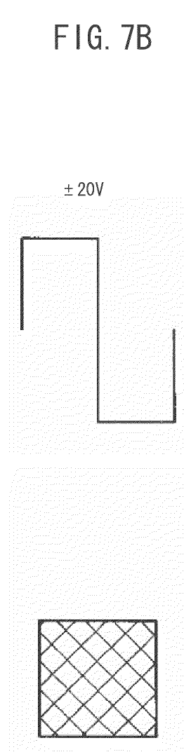

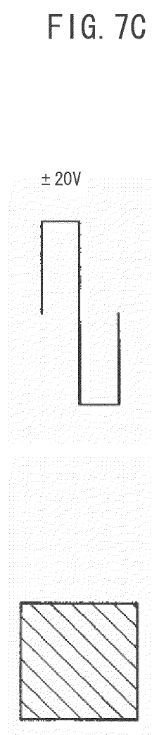

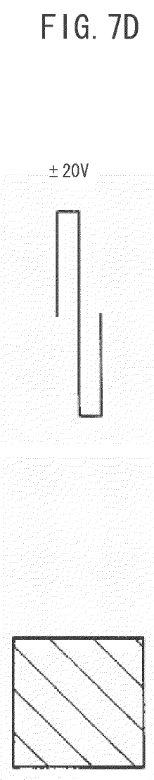

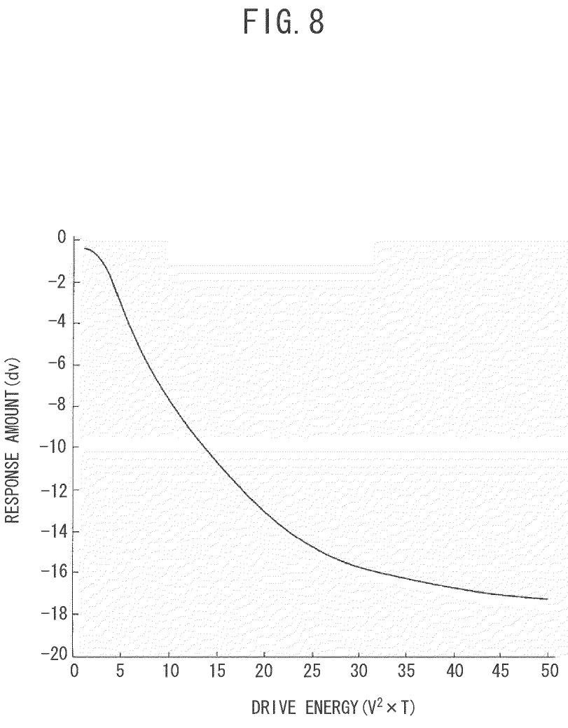

First, a response characteristic with respect to the applied energy in a kind of display device using cholesteric liquid crystal will be described with reference to FIG. 8. FIG. 8 is a graph showing the change of brightness (reflectance) when a voltage pulse of ±20 V is applied after the initialization to bring the liquid crystal into the planar state. This is done by performing the first step of FIG. 7A of applying a voltage pulse of ±36 V with a pulse width of several tens of ms. In FIG. 8, the horizontal axis represents the drive energy expressed by the product of the square of the voltage and the pulse width of the voltage pulse, and the vertical axis represents the response amount expressed by a change amount dY of the brightness. The drive energy is changed by changing the pulse width of the voltage pulse.

The inventor of the present application has found, from the research results obtained heretofore, that the response amount of cholesteric liquid crystal is highly correlated with the product V²T of the square of the voltage V and the pulse width T of the voltage pulse, that is, the energy of the capacitive load, which is different from that of typical STN liquid crystal correlated with the product VT of the voltage V and the pulse width T. However, as shown in FIG. 8, the inclinations of the change of the response amount in the high tone part where the response amount dY is 0 to −2 and in the low tone part where the response amount dY is −14 or less are smaller than that in the intermediate tone part where the response amount dY is −2 to −14. In other words, the energy required for deriving a response amount is relatively high in the high tone part and in the low tone part compared with the intermediate tone part.

The following two are considered as reasons why the response amount is small in the high tone part.

(1) In the high tone part, since the drive energy is low, the liquid crystal molecules cannot escape from the interfacial bound state.

(2) The liquid crystal device is susceptible to obtuseness of the waveform of the voltage pulse due to the CR characteristic of the panel.

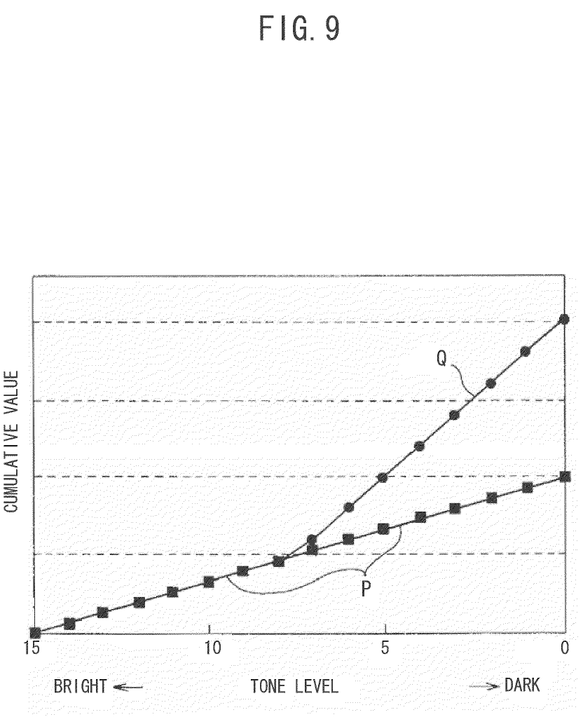

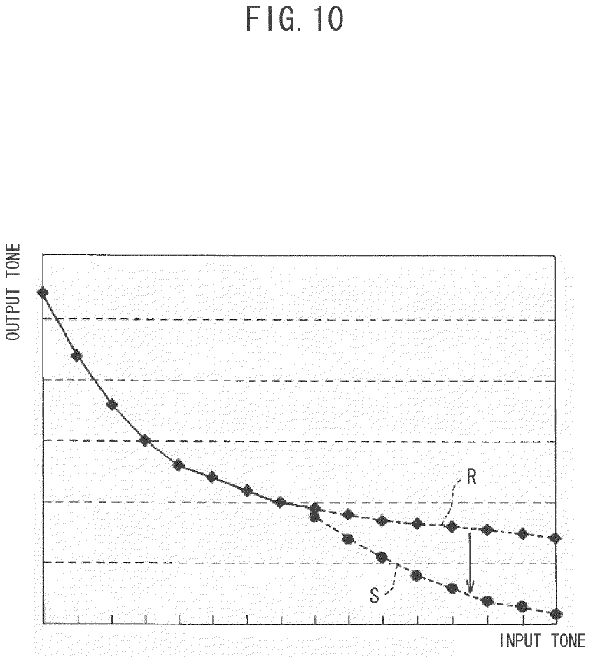

FIGS. 9 and 10 are views for explaining the correction of the difference in energy cumulative value from adjoining tones in the low tone part so as to be larger than that in the intermediate part for the expansion of the display range of the low tones.

FIG. 9 is a view showing the relations between the tone level to be displayed and the cumulative value of the drive energy. In FIG. 9, the line shown by P represents the relation where the cumulative value of the drive energy increases in proportion to the tone level with a first proportionality factor. On the contrary, in the line shown by Q, the proportionality factor is changed at a tone level in the middle.

FIG. 10 is a view showing the relation between the input tone and the output tone when the relation in FIG. 9 is used. In FIG. 10, the line R represents the relation between the input tone and the output tone when the relation represented by P in FIG. 9 is used, and the line S represents the relation between the input tone and the output tone when the relation represented by Q in FIG. 9 is used. As shown in the figure, it is apparent that the low tone part of the output tone expands toward the low side.

As described above, the effects are obtained of expanding the low tone range, reducing the tone blurring in low tones, improving the responsiveness in low tones, and improving contrast.

The inventor of the present application has found that for further expansion of the display range in the low tone part, it is effective to increase the voltage of the voltage pulse. When the drive energy of one voltage pulse is made the same, the pulse width is made smaller at a voltage higher than the voltage pulse applied to intermediate tones.

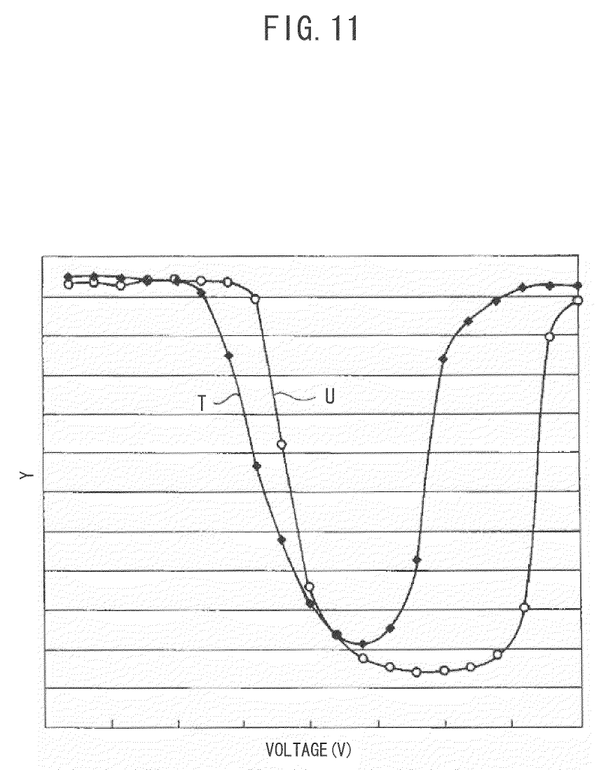

FIG. 11 is a view showing the change of the brightness Y when one voltage pulse with a pulse width of 10 ms and five voltage pulses with a pulse width of 2 ms are applied to the liquid crystal at different voltages. The line T represents a case where one voltage pulse of 10 ms is applied, and the line U represents a case where five voltage pulses of 2 ms are applied. In this case, although the execution times of the two are the same, it is apparent that a lower brightness can be realized by the five pulses of 2 ms than by the one pulse of 10 ms and the voltage where the brightness is lowest with the five pulses of 2 ms is higher than the voltage where the brightness is lowest with the one pulse of 10 ms. In other words, in the low tone part, the lowest brightness can be made lower, that is, the display range of the low tones can be expanded to improve contrast by applying a voltage pulse of 2 ms five times to increase the voltage than by cumulatively applying a voltage pulse of 10 ms.

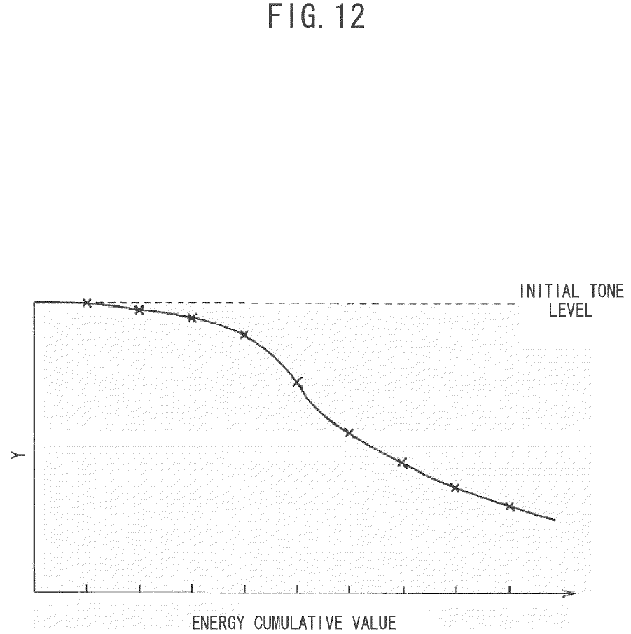

FIG. 12 is a view showing the characteristic of the high tone part of FIG. 8 so as to be enlarged. As shown in the figure, for energy cumulative values of tone levels 1 to approximately 4, the change amount of the brightness Y is small. When the tone level is changed from 4 to 5, further to 6, the change amount of the brightness Y is temporarily large. Thereafter, the change amount is substantially constant. Therefore, for energy cumulative values of tone levels 1 to approximately 4, tone blurring occurs, and when the tone levels are 4 to 6, tone omission occurs.

Therefore, in the high tone part, the intervals between the energy cumulative values corresponding to the tones are increased.

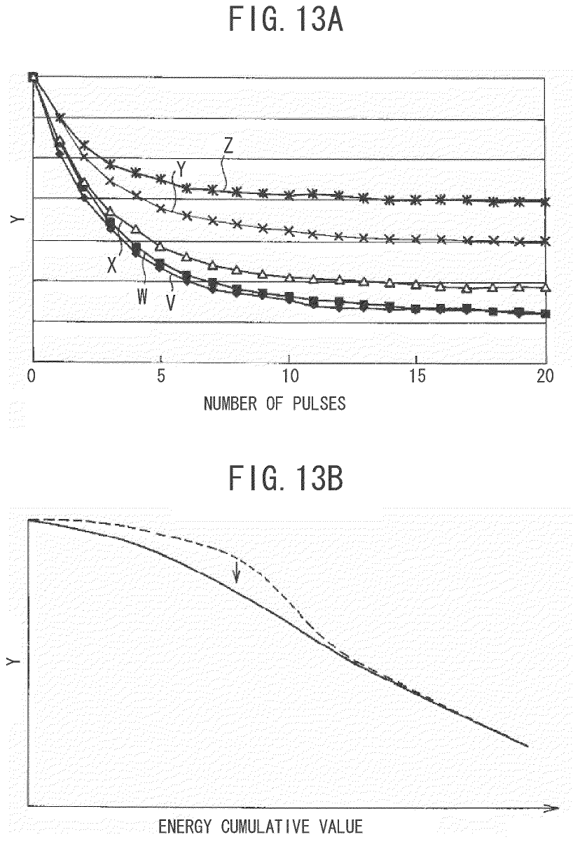

Further, the inventor of the present application has found that when high tones are displayed, by applying a voltage pulse of a long period at a relatively low voltage compared with when intermediate tones are displayed, the energy cumulative value applied to the liquid crystal and the brightness (tone) change in the high tones approach a linear change and tone setting is facilitated. FIGS. 13A and 13B are views for explaining this.

FIG. 13A shows the change of the brightness Y corresponding to the number of applied pulses when the voltage V and the pulse width T are changed under a condition where the product V²T of the square of the voltage V and the pulse width T of the voltage pulse is constant. Here, the voltage V and the pulse width T are changed with reference to a case where they are ±20 V and 0.5 ms, respectively. The lines V, W, X, Y, and Z represent cases where the voltage V is 16 V, 18 V, 20 V, 22 V, and 24 V, respectively. From FIG. 13A, it is apparent that the tone change is larger and more advantageous response is obtained when a voltage pulse of a lower voltage and a wider pulse width is applied. In other words, while a high voltage and a short pulse are advantageous in the low tone part, a low voltage and a wide pulse are advantageous in the high tone part.

FIG. 13B is a view showing the change of the relation (response characteristic) between the energy cumulative value and the brightness Y in the high tone part when the voltage pulse used is changed from a voltage pulse of 20 V to a voltage pulse of 22 V. As shown in the figure, it is apparent that the energy cumulative value applied to the liquid crystal, and the brightness (gradation) change in the high tones, approach a linear change. Thereby, tone setting is facilitated.

As described above, it has been found that in the high tone part and the low tone part, it is advantageous in tone expression to make the difference in the energy cumulative value of the applied voltage pulse from adjoining tones larger than that in the intermediate tone part, and it is advantageous in uniform tone expression to apply a low-voltage wide pulse to the high tone part and apply a high-voltage narrow pulse to the low tone part.

Next, an embodiment of the cholesteric liquid crystal display apparatus to which the above-described driving method is applied will be described.

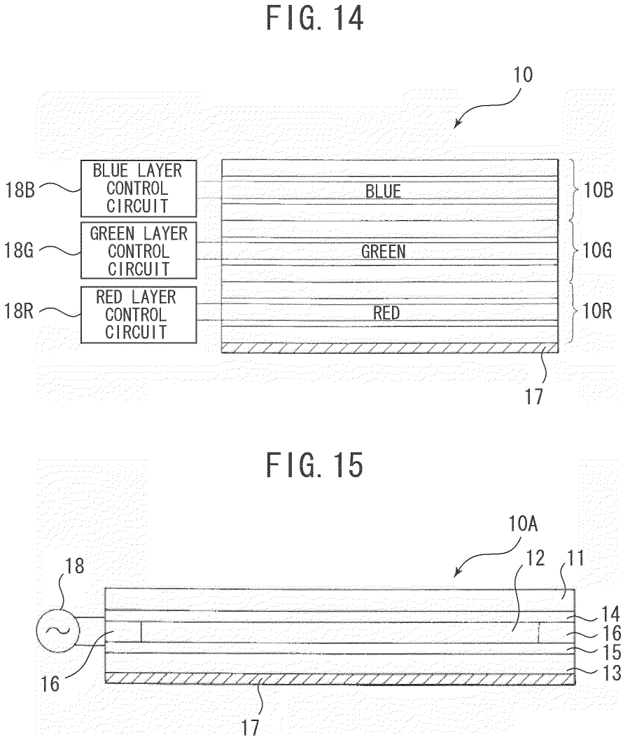

FIG. 14 is a view showing the structure of a display device 10 used in the embodiment. As shown in FIG. 14, in the display device 10, three panels of a blue panel 10B, a green panel 10G, and a red panel 10R are laminated from the viewing side, and a light absorbing layer 17 is provided under the red panel 10R. Although the panels 10B, 10G, and 10R have the same structure, liquid crystal materials and chiral materials are selected and the contents of the chiral materials are determined so that the center wavelength of reflection of the blue panel 10B is blue (approximately 480 nm), the center wavelength of reflection of the green panel 10G is green (approximately 550 nm), and the center wavelength of reflection of the red panel 10R is red (approximately 630 nm). The panels 10B, 10G, and 10R are driven by a blue layer control circuit 18B, a green layer control circuit 18G, and a red layer control circuit 18R, respectively.

FIG. 15 is a view showing the basic structure of one panel 10A of the three panels 10B, 10G, and 10R constituting the display device 10 of FIG. 14. The structures of the three panels 10B, 10G, and 10R are substantially the same except for the reflection wavelength. The panel used in the embodiment will be described with reference to FIG. 15.

As shown in FIG. 15, the display device 10A has an upper substrate 11, an upper electrode layer 14 provided on the surface of the upper substrate 11, a lower electrode layer 15 provided on the surface of a lower substrate 13, and a sealing material 16. The upper substrate 11 and the lower substrate 13 are disposed so that the electrodes are opposed thereto, and the liquid crystal material is filled therebetween and sealed in by the sealing material 16. Although spacers are disposed in a liquid crystal layer 12, they are not shown. A voltage pulse signal is applied to the electrodes of the upper electrode layer 14 and the lower electrode layer 15 from a drive circuit 18. Thereby, a voltage is applied to the liquid crystal layer 12. By applying the voltage to the liquid crystal layer 12, the liquid crystal molecules in the liquid crystal layer 12 are brought into the planar state or the focal conic state to perform display.

While the upper substrate 11 and the lower substrate 13 both have translucency, the lower substrate 13 of the red panel 10R may be opaque. While an example of the translucent substrate is a glass substrate, a film substrate of polyethylene terephthalate (PET), polycarbonate (PC), or the like may be used as well as the glass substrate.

While a representative example of the material for the electrodes of the upper electrode layer 14 and the lower electrode layer 15 is indium tin oxide (ITO), a transparent conductive film of indium zinc oxide (IZO) or the like may be used as well.

The transparent electrodes of the upper electrode layer 14 are formed on the upper substrate 11 as a plurality of strip-shaped upper transparent electrodes parallel to one another. The transparent electrodes of the lower electrode layer 15 are formed on the lower substrate 13 as a plurality of strip-shaped lower transparent electrodes parallel to one another. The upper substrate 11 and the lower substrate 13 are disposed so that the upper electrodes and the lower electrodes intersect each other when viewed from a direction vertical to the substrate, and pixels are formed at the intersections. An insulative thin film is formed on the electrodes. When this thin film is thick, the drive voltage may increase, so that it is difficult to form the drive circuit of a general-purpose STN driver. Conversely, when no thin film is formed, a leakage current may flow, so that power consumption is increased. In this example, since the relative dielectric constant of the thin film is approximately 5.0, which is considerably lower than that of the liquid crystal, it is appropriate that the thickness of the thin film be appropriately 0.3 μm or less.

The insulative thin film may be realized by an SiO₂ thin film or an organic film of polyimide resin, acrylic resin or the like known as an orientation stabilization film.

As described above, spacers are disposed in the liquid crystal layer 12 so that the distance between the upper substrate 11 and the lower substrate 13, that is, the thickness of the liquid crystal layer 12 is uniform. While spacers are typically spheres made of a resin or an inorganic oxide, adhesive spacers where the substrate surfaces are coated with a thermoplastic resin may be used. It is appropriate that the cell gap formed by the spacers be in a range of 3.5 μm to 6.0 μm. When the cell gap is smaller than this value, the reflectance is decreased to make the display dark, and when the cell gap is larger than this value, the drive voltage is increased to make driving by a general-purpose driver IC difficult.

The liquid crystal constituent forming the liquid crystal layer 12 is a cholesteric liquid crystal in which 10 wt % to 40 wt % of chiral material is added to a nematic liquid crystal mixture. Here, the addition amount of the chiral material is the value when the total amount of the nematic liquid crystal component and the chiral material is 100 wt %.

While various known kinds may be used as the nematic liquid crystal, it is desirable that the nematic liquid crystal be a liquid crystal material with a dielectric anisotropy (Δε) of 15 to 35. When the dielectric anisotropy is 15 or more, the drive voltage is comparatively low, and when the dielectric anisotropy is higher than this range, although the drive voltage itself is low, the resistivity is low, and power consumption is high, particularly, at high temperatures.

It is desirable that the refractive index anisotropy (Δn) be 0.18 to 0.24. When the refractive index anisotropy is lower than this range, the reflectance in the planar state is low, and when the refractive index anisotropy is higher than this range, not only the diffuse reflectance in the focal conic state is high but also the viscosity is high and the response speed is low.

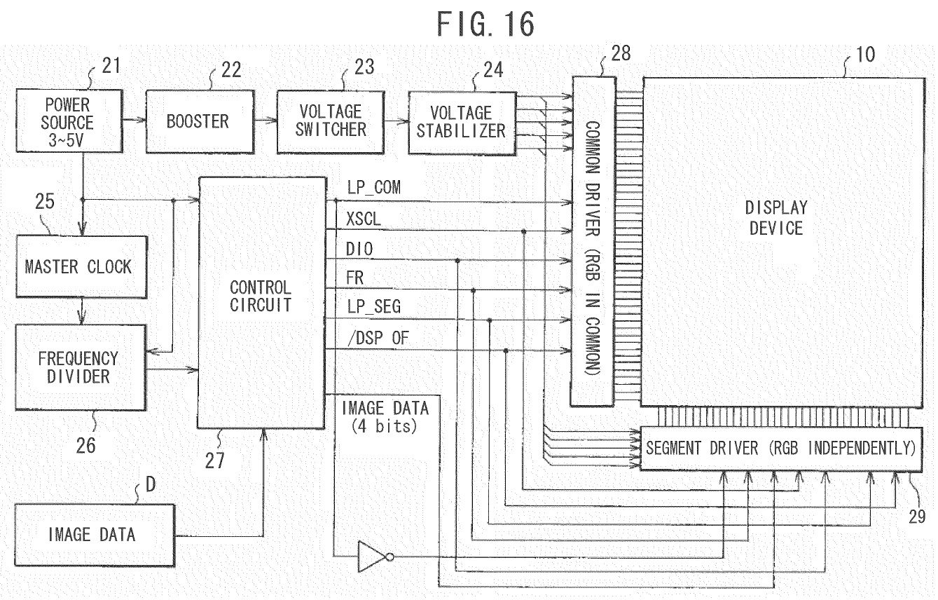

FIG. 16 is a view showing the general structure of the display apparatus of the embodiment. The display device 10 is of A4 size and XGA format, and has 1024×768 pixels. A power source 21 outputs a voltage of, for example, 3 V to 5 V. A booster 22 raises the input voltage from the power source 21 to 36 V to 40 V by a regulator such as a DC-DC converter. As the booster regulator, a dedicated IC is widely used, and the IC has the function of adjusting the boosted voltage by setting a feedback voltage. Therefore, the boosted voltage can be changed by selecting a plurality of voltages generated by voltage division by resistance or the like and supplying them to a feedback terminal.

A voltage switcher 23 generates various voltages by resistance division or the like. While a high-voltage analog switch may be used for the switching between a reset voltage and a tone writing voltage by the voltage switcher 23, a simple switching circuit by a transistor may be used. As a voltage stabilizer 24, a voltage follower circuit of an operational amplifier is desirably used in order to stabilize various voltages supplied from the voltage switcher 23. As the operational amplifier, one that is resistant to the capacitive load is desirably used. A structure of switching the amplification factor by switching the resistance coupled to the operational amplifier is widely known, and by using this structure, the voltage outputted from the voltage stabilizer 24 can be easily switched.

A master clock portion 25 generates a basic clock on which operations are based. A frequency divider 26 divides the basic clock to generate various clocks necessary for operations described later.

A control circuit 27 generates a control signal based on the basic clock, various clocks, and image data D, and supplies it to a common driver 28 and a segment driver 29.

The common driver 28 drives 768 scan lines, and the segment driver 29 drives 1024 data lines. Since the image data supplied to each of the RGB pixels is different, the segment driver 29 independently drives the data lines. The common driver 28 drives RGB lines in common. In the present embodiment, a general-purpose binary-output STN driver is used as the driver IC. As the general-purpose STN driver, various ones may be used.

The image data inputted to the segment driver 29 is 4-bit data D0-D3 where a full-color original image is converted into 4096-color data of 16 tones for each of R, G, and B by the error diffusion method. For this tone conversion, a method by which a high display quality is obtained is desirable, and the blue-noise mask method may be used as well as the error diffusion method. Moreover, image quality improving processing such as contrast enhancement processing may be performed before and after the tone conversion.

Next, an image writing operation in the present embodiment will be described.

The drive sequence of the present embodiment has a first step S1 of initializing the cholesteric liquid crystal in the pixels so that the initial tones are displayed, and a second step S2 of changing the initial tones. At the second step S2, seven sub voltage pulses SB1 to SB7 are outputted, the applied sub voltage pulse is selected according to the tone, and the tone is set according to the energy cumulative value of the sub voltage pulse.

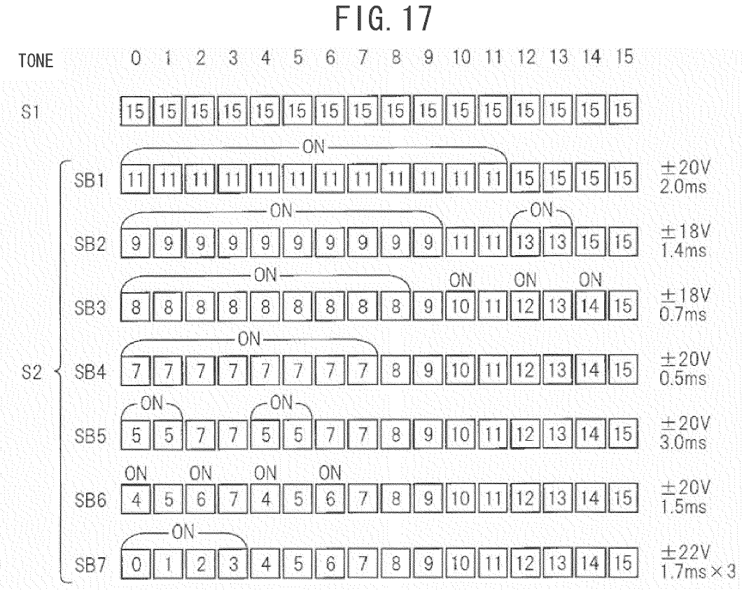

FIG. 17 is a view showing the selection from among the seven sub voltage pulses SB1 to SB7 for each tone at the second step S2. The top line shows tones, the second line shows the tones after the first step S1, and the third to ninth lines show the tones after the selection and application of the sub voltage pulses SB1 to SB7 at the second step S2. In each of the third to ninth lines, selection is made so that the sub voltage pulse is applied to the tone when marked with ON. The first step S1 is performed on all the tones to thereby initialize the tones to tone 15. At the next second step S2, for example, to the pixel of tone 1, SB1 to SB5 and SB7 are selected and applied. To tone 6, SB1 to SB4 and SB6 are selected and applied. To tone 14, only SB3 is selected and applied.

The pulse characteristics of the sub voltage pulses SB1 to SB7 are shown on the right side of the third to ninth lines. For example, SB1 is a voltage pulse of a voltage of ±20 V and a pulse width of 2.0 ms. SB3 is a voltage pulse of a voltage of ±22 V and a pulse width of 0.7 ms. SB6 is a voltage pulse of a voltage of ±20 V and a pulse width of 1.5 ms. What are to be noted here are that SB1 and SB4 to SB6 are pulses of a voltage of ±20V, SB2 and SB3 are pulses of a voltage of +18 V, and SB7 is a pulse of a voltage of ±22 V and that SB7 is constituted by three pulses with a pulse width of 1.7 ms.

As is apparent from FIG. 17, the difference in the energy cumulative value of the applied voltage pulse from adjoining tones is larger in the high tone part and the low tone part than in the intermediate tone part. Thereby, tone blurring and tone omission can be reduced.

Further, as shown in FIG. 17, for high tones of tones 12 to 14, one or both of SB2 and SB3 are selected. That is, only low-voltage wide pulses are applied. With respect to the intermediate tones, while only SB1 is applied to tone 11 and one or both of SB2 and SB3 are applied to tones 4 to 10, the other voltages of ±20 V are also applied, and the proportion of the pulses of ±18 V in the energy cumulative value is relatively small. To tones 0 to 3, while both SB2 and SB3 are applied and the pulses of ±20 V are also applied, since three pulses of ±22 V and 1.7 ms are applied, the proportion of the ±22 V pulses in the energy cumulative value is relatively large. Therefore, the above-mentioned advantage is obtained in which it is advantageous in obtaining uniform tone expression to apply a low-voltage wide pulse to the high tone part and apply a high-voltage narrow pulse to the low tone part. It is to be noted that even if the relation between the tones and the energy cumulative value of the applied voltage pulse shown in FIG. 17 is applied only to one of the high tone part and the low tone part, effects corresponding thereof are obtained.

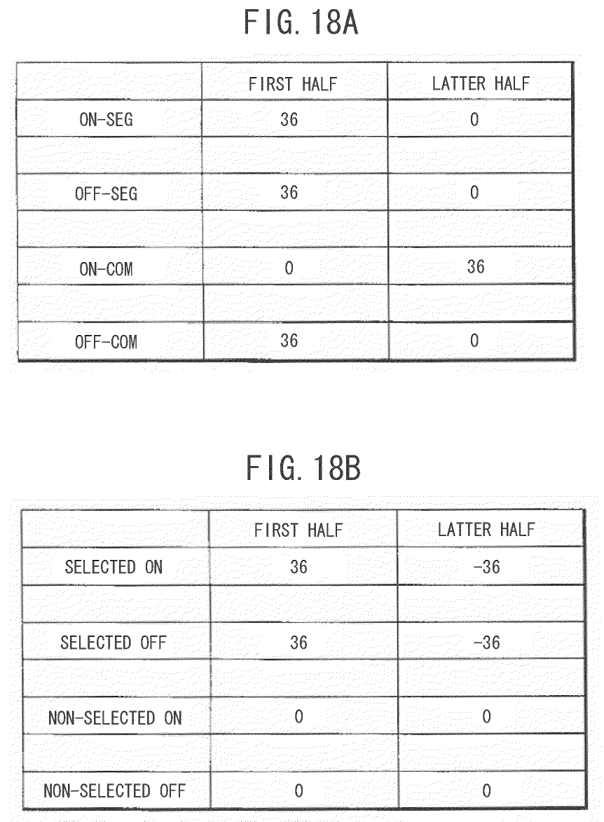

FIGS. 18A and 18B are views showing the output voltages of the segment driver 29 and the common driver 28 and the voltages applied to the liquid crystal thereby at the first step S1, that is, when all the pixels are initialized.

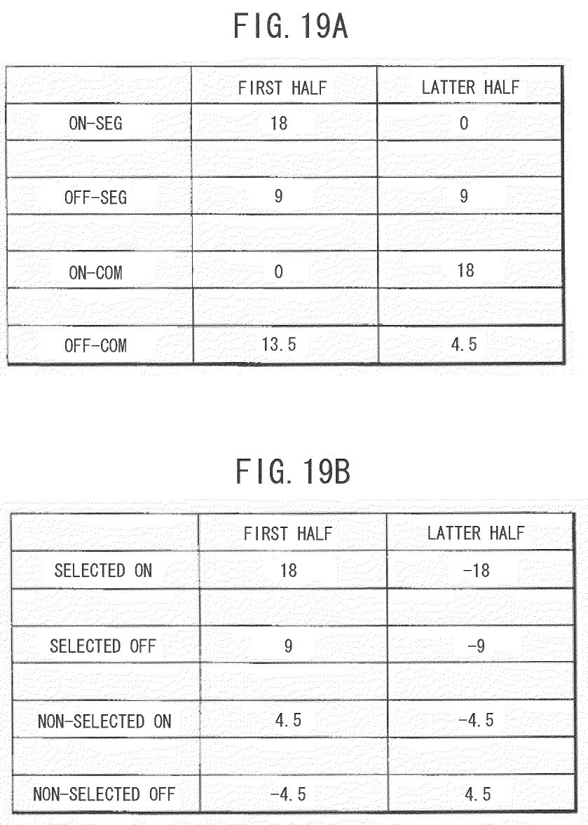

FIGS. 19A and 19B are views showing the output voltages of the segment driver 29 and the common driver 28 and the voltages applied to the liquid crystal thereby when SB2 and SB3 are applied.

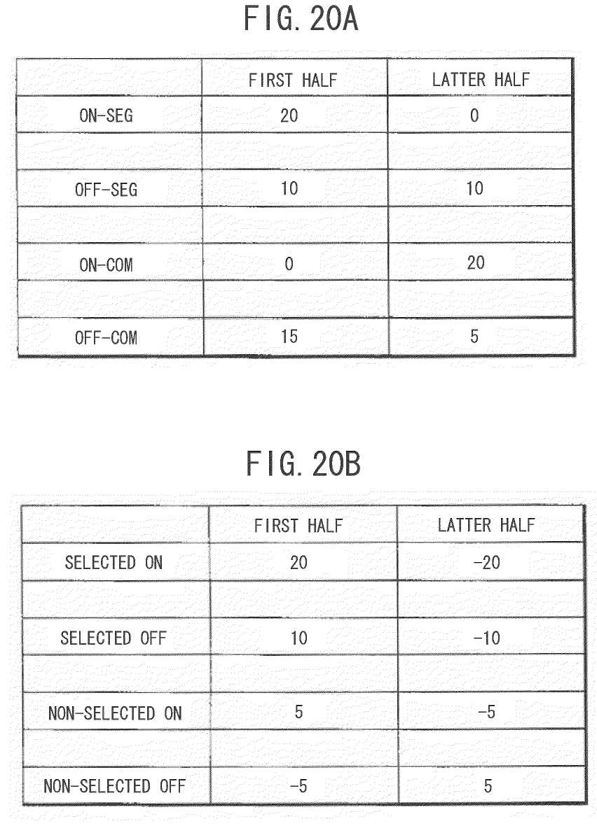

FIGS. 20A and 20B are views showing the output voltages of the segment driver 29 and the common driver 28 and the voltages applied to the liquid crystal thereby when SB1 and SB4 to SB6 are applied.

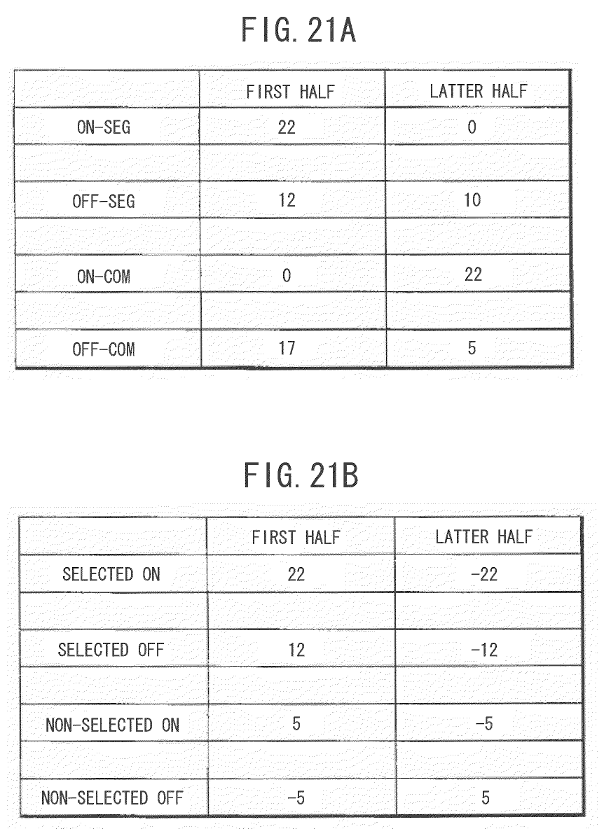

FIGS. 21A and 21B are views showing the output voltages of the segment driver 29 and the common driver 28 and the voltages applied to the liquid crystal thereby when SB7 is applied.

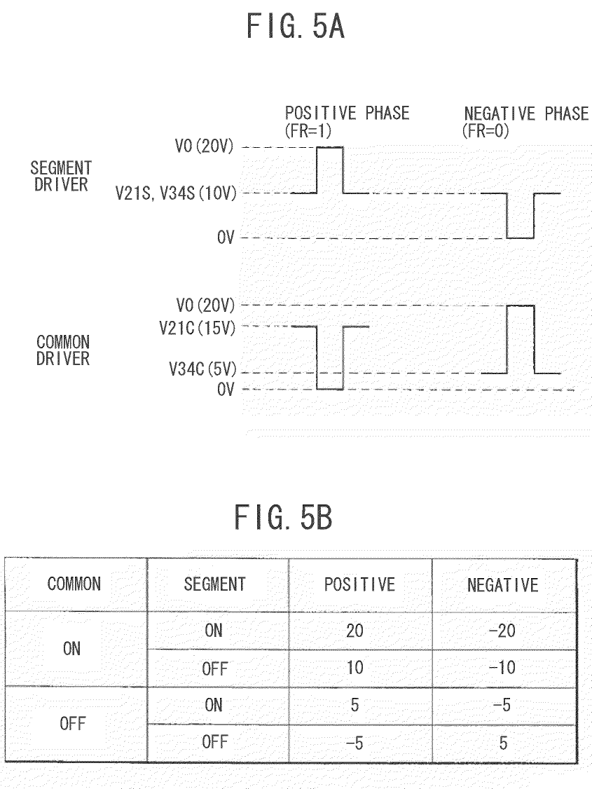

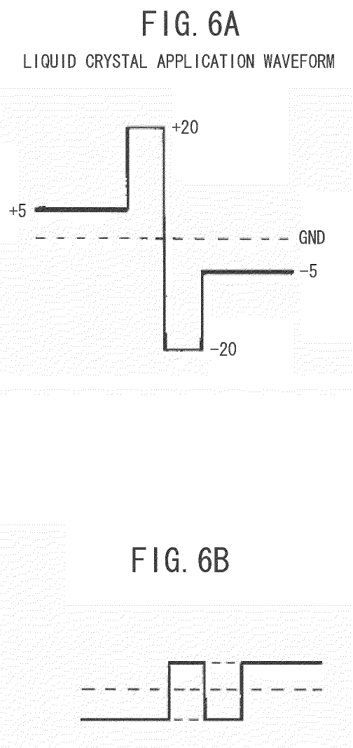

The relation between the output voltages of the drivers and the voltages applied to the liquid crystal is not described here because they were described with reference to FIG. 5. The output voltages of the drivers are changed by switching the voltages supplied from the voltage stabilizer 24 to the common driver 28 and the segment driver 29.

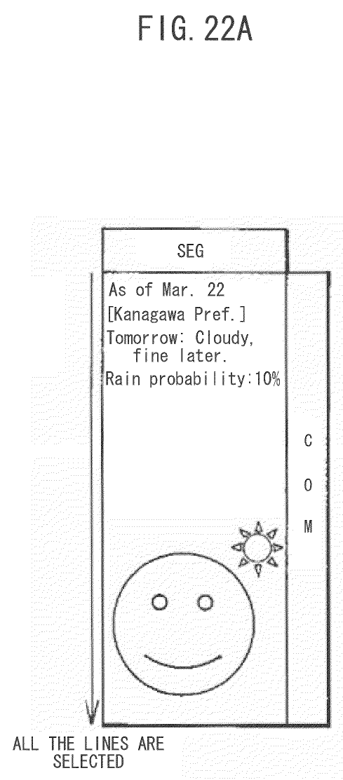

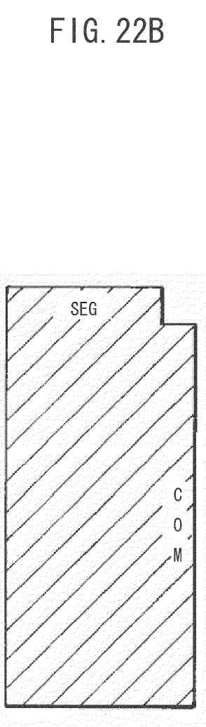

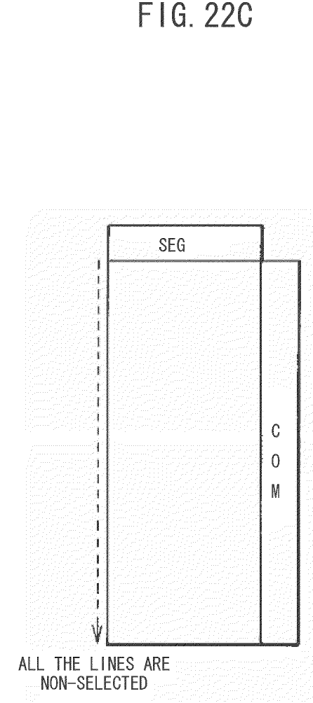

FIG. 22A is a view showing a screen change by full-screen planar reset processing to bring all the pixels into the planar state at the first step S1.

Before the first step S1 is started, an image is displayed as shown in FIG. 22A.

When the first step S1 is started, after the output voltages of the segment driver 29 are all set at the ground (GND) level, all the output lines of the common driver 28 are brought into a selected state. To set all the output voltages at the GND level, /DSPOF is set at low (L).

Then, after a polar signal FR is set at high (H) level, /DSPOF is set at H level. Then, +36 V is applied to all the selected lines, so that all the pixels are brought into the homeotropic state, as shown in FIG. 22B.

Then, the polar signal FR is set at low (L) level to thereby reverse the voltages applied to all the lines from +36 V to −36 V.

While the appropriate application times of +36 V and −36 V differ according to the structure of the display device, in the present embodiment, the signals are pulses with a pulse width of several tens of ms.

Lastly, /DSPOF is set at L to make the output 0 V. Then, the state of all the pixels is changed from the homeotropic state to the planar state shown in FIG. 22C. In this way, the full-screen planar reset processing is ended. When /DSPOF is used, discharge is forcibly caused at the short circuit of the driver IC, so that the discharge time of charging and discharging of the display device can be shortened. Since the transition to the planar state requires steepness of voltage pulses, with this forcible discharge using /DSPOF, the pixels can be reset to the planar state with reliability even in the case of large-size display devices.

At the second step S2, the sub voltage pulses SB1 to SB7 are applied to the selected pixels in frames F1 to F7. Before each frame is started, voltages to apply the corresponding sub voltage pulses are inputted from the voltage stabilizer 24 to the common driver 28 and the segment driver 29. The frequency divider 26 outputs a timing signal, such that a pulse corresponding to the pulse width of the sub voltage pulse is generated, to the control circuit 27 for each frame. The scan operation in each frame is not described in detail because it is similar to the conventional example and widely known.

The sub voltage pulses SB1 to SB7 may be applied in such a manner that the application is performed separately in frames where the three sub voltage pulses SB1 to SB3 are applied, frames where the three sub voltage pulses SB4 to SB6 are applied, and frames where SB7 is applied as in the example described in Japanese Unexamined Patent Application Publication No. 2007-111523. In this case, however, it is necessary to change the voltage outputted from the voltage stabilizer 24 while the same line is being scanned, and the voltage stabilizer 24 is required to have the function of quickly switching the voltage.

In any case, with respect to how the sub voltage pulses SB1 to SB7 are applied, various modifications are possible.

Moreover, a high-speed display mode (hereinafter, referred to as “draft mode”) to which the driving method of the liquid crystal display device 10 of the above-described embodiment is applied can be executed. In the draft mode, the second step S2 is ended at the point in time when the execution of some of a plurality of sub step groups of the second step S2 is finished. For example, the liquid crystal display apparatus is provided with a system that stops the second step S2 at the point in time when image data writing is finished, at a sub step group constituted by the first to third sub steps SB1 to SB3 of the second step S2 shown in FIG. 17. In this draft mode, since the second step S2 is ended at the point in time when the third sub step SB3 is finished, pseudo 512-color display is performed, which is a transitional state of 4096-color display. For this reason, in the draft mode, although the display quality is inferior to that of normal operation, images can be written in a short time, so that display contents can be quickly recognized. Moreover, 512 colors are sufficient for the recognition of display contents. Users of liquid crystal display apparatus having the draft mode can successively update display contents at intervals like those of page turning.

While the embodiment is described, it is to be noted that various modifications are possible.

For example, while an example of the three-layer color cholesteric liquid crystal display apparatus shown in FIG. 14 is described, the present invention is similarly applicable to the single-layer cholesteric liquid crystal display device shown in FIG. 15 and to a two-layer cholesteric liquid crystal display apparatus.

While an example using /DSPOF is described as the full-screen planar reset processing to initialize the full screen to the planar state, for example, the initialization to the planar state may be performed by scanning lines one by one.

While an example of the writing processing to bring each pixel from the planar state to the desired tone by combining the sub voltage pulses SB1 to SB7 shown in FIG. 17 is described, the kinds of sub voltage pulses may be increased so that only a voltage pulse of ±20 V is applied to the intermediate tones.

While an example in which the present invention is applied to a dot-matrix display device is described in the embodiment, the present invention is similarly applicable to a segment display device.

What is claimed is:

1. A drive circuit of a liquid crystal display device, comprising:
a driver circuit that applies a voltage pulse to a liquid crystal of the liquid crystal display device; and
a control circuit that controls the driver circuit to change the liquid crystal to a initial tone and to change the initial tone to a high tone, an intermediate tone, or a low tone, wherein
the control circuit sets a tone energy difference so as to be smaller at the intermediate tone than at the high tone close to the initial tone, the tone energy difference being a difference between an application energy of the voltage pulse applied to the liquid crystal of the initial tone to display a predetermined tone and an application energy of the voltage pulse applied to display a tone different from the predetermined tone.

2. The drive circuit of the liquid crystal display device according to claim 1, wherein
the control circuit sets the tone energy difference so as to be larger at the low tone than at the intermediate tone.

3. The drive circuit of the liquid crystal display device according to claim 1, wherein
the application energy is calculated from a voltage value and a pulse period of the voltage pulse.

4. The drive circuit of the liquid crystal display device according to claim 3, wherein
the application energy is a product of a square of the voltage value and the pulse period of the voltage pulse.

5. The drive circuit of the liquid crystal display device according to claim 1, wherein
the liquid crystal includes cholesteric liquid crystal.

6. The drive circuit of the liquid crystal display device according to claim 1, wherein
the control circuit displays the pixel of the high tone prior to the pixel of the low tone.

7. A drive circuit of a liquid crystal display device, comprising:
a driver circuit that applies a voltage pulse to a liquid crystal of the liquid crystal display device; and
a control circuit that controls the driver circuit to change the liquid crystal to a initial tone and to change the initial tone to a high tone, an intermediate tone, or a low tone, wherein
the control circuit selects, from among a plurality of sub voltage pulses having pulses of different voltage values and pulse widths, the sub voltage pulse corresponding to a tone to which the initial tone is to be changed, and sets the tones according to an energy cumulative value of the sub voltage pulse.

8. The drive circuit of the liquid crystal display device according to claim 7, wherein
when the low tone far from the initialized tone is displayed, the control circuit applies a voltage pulse of a higher voltage and a shorter pulse width than when the intermediate tone is displayed.

9. The drive circuit of the liquid crystal display device according to claim 7, wherein
when the high tone close to the initialized tone is displayed, the control circuit applies a voltage pulse of a relatively lower voltage and a longer pulse width than when the intermediate tone is displayed.

10. The drive circuit of the liquid crystal display device according to claim 7, wherein
the energy is calculated from the voltage value and the pulse width.

11. The drive circuit of the liquid crystal display device according to claim 10, wherein
the energy is a product of a square of the voltage value and a pulse period of the voltage pulse.

12. The drive circuit of the liquid crystal display device according to claim 7, wherein
the liquid crystal includes cholesteric liquid crystal.

13. The drive circuit of the liquid crystal display device according to claim 7, wherein
the control circuit displays the pixel of the high tone prior to the pixel of the low tone.

14. A liquid crystal display apparatus comprising:
a liquid crystal display device; and
a drive circuit that drives the liquid crystal display device so as to perform multi-tone display, wherein
the drive circuit outputs an initialization pulse to a liquid crystal of the liquid crystal display device so as to display an initial tone and a tone pulse having a plurality of sub voltage pulses to change the initial tone to a high tone, an intermediate tone, or a low tone, selects the sub voltage pulse to be applied, according to a tone to which the initial tone is to be changed, and sets the tone according to an energy cumulative value of the sub voltage pulse, and
the plurality of sub voltage pulses are pulses of different voltage values and pulse widths.

15. The liquid crystal display apparatus according to claim 14, wherein
a voltage pulse of a higher voltage and a shorter pulse width than when the intermediate tone is displayed is applied to the low tone far from the initial tone.

16. The liquid crystal display apparatus according to claim 15, wherein
a voltage pulse of a lower voltage and a longer pulse width than when the intermediate tone is displayed is applied to the high tone close to the initial tone.

17. The liquid crystal display apparatus according to claim 14, wherein
the energy is calculated from the voltage value and the pulse width.

18. The liquid crystal display apparatus according to claim 17, wherein
the energy is a product of a square of the voltage value and a pulse period of the voltage pulse.

19. The liquid crystal display apparatus according to claim 14, wherein
the liquid crystal includes cholesteric liquid crystal.

20. The liquid crystal display apparatus according to claim 14, wherein
the drive circuit displays the pixel of the high tone prior to the pixel of the low tone.
